(19) United States
(12) Patent Application Publication
(10) Pub. No.: US 2008/0110670 A1
(43) Pub. Date: May 15, 2008

(54) Information jack's circuit board layout

(76) Inventor: Yu Cheng Lin, Taoyung (TW)

Correspondence Address: NATH & ASSOCIATES PLLC, 112 South West Street, Alexandria, VA, 22314, US

(21) Appl. No.: 11/595,866

(22) Filed: Nov. 13, 2006

(51) Int. Cl. H01R 12/04

(52) U.S. Cl. 174/261

(57) ABSTRACT

A double-sided printed circuit board (PCB) layout for an information jack has an information jack terminal and an IDC wiring terminal together with a number of pairs of condensers, a number of pairs of power inducers, main lead wires, a number of pairs of leads, and extension lead wires. The PCB contains a circuit lead wire structure for the jack terminal and for the IDC wiring terminal and eight pins for each terminal separated into pairs wherein pair one is comprised of pins 4 and 5 and pair three is comprised of pins 3 and 6. Pair one's 4, 5 pins and Pair three's 3, 6 pins are separated and located on different sides of the PCB. In this way the power inducting effect and power condensing effect generated from the main leads and extension leads are utilized to achieve the objective of reducing cross-take and improving return loss, thereby allowing the two to surpass Category 6 communications protocols for improving correct signal transmission and maximizing the product's overall operating yield.

### FIELD OF THE INVENTION

The invention pertains to an information receptacle's circuit layout structure, intended for the needs of printed circuit boards complying with category-6 communications protocols

### BACKGROUND OF THE INVENTION

This invention intended for the needs of printed circuit boards complying with category-6 communications protocols, which operates on the premise of separating the main lead wires of pins 4 and 5 of pair one, and pins 3 and 6 of pair two on the information jack and IDC terminal along the different side of the PCB

A prior information jack's circuit layout (the Taiwanese application number: 900216170) has Pair one's pin 4, 5 and Pair three's pin 3, 6 placed separately to two sides of the PCB, where pin 3, 5 and pin 4, 6 are joined to form power condensing effect, and pin 4, 6 or pin 3, 5 are made to form TF or RR power inducting effect on the information jack end, and that pin 3, 4 or pin 5, 6 are made to form TR power inducting effect for counterbalance on the IDC terminal end for reducing the cross-talk phenomenon.

### SUMMARY OF THE INVENTION

An objective of the invention lies in maximizing the stability of signal transmission and the normal transmission speed of equipment signal to bring the transmission of audiovisual effects to a perfected state and increase the quality of living in communications transmission.

The preferred embodiment of the invention pertains to an information receptacle's circuit layout structure of a double sided Printed Circuit Boards (PCB) complying with category-6 communications protocols. These protocols have the main lead wires of pins 4 and 5 of pair one, and pins 3 and 6 of pair two separated on the information jack and IDC terminal along the different side of the PCB, and a specific main circuit lead wire is configured in proximity at a certain distance to form the power inducting and power condensing effects, where the power condensing effect achieved through placing the lead wires in proximity to the two sides of the IDC terminal and the information jack, coupled with an equilibrium of a multiple power inducting and power condensing, serve to reduce the cross talk and return-loss interference to comply with category 6 protocols.

The invention devises an information jack's power layout, which places pair one's pin 4 and pin 5 on different sides of a PCB, pair 3's pin 3 and pin 6 are also placed on different sides of a PCB, where pin 3, 5 on same side of a PCB near the main leads create pair pair's power inducting effect and pair one's power condensing effect, and pin 4, 6 on the same side of a PCB near the main leads also create pair two's power inducting effect and pair two's power condensing effect.

Then by utilizing pin 4, 6 or pin 3, 5 at the information jack that come to create TT, RR pair three's power condensing effect, which is counterbalanced by pin 3, 4 or pin 5, 6 at the IDC terminal that come to create TR pair four's power condensing effect to reduce the cross-talk phenomenon and surpass category-six. Pair one and pair three's return loss benefit from pin 4, 5 locating on two sides of a PCB and pin 3, 6 located on two sides of a PCB that bring its impedance closer to 100 Ω to pair with the circuit's 100 Ω impedance, and allow its return loss also to surpass category-six communications protocols.

### BRIEF DESCRIPTION OF THE DRAWINGS

FIG. 1 is an electrical schematic diagram of an equalizing effects circuit of an information jack's Printed Circuit Board (PCB) layout according to invention;

FIG. 2 is a top plan view of a circuit board layout depicting part of the circuit of FIG. 1;

FIG. 3 is a bottom plan view of the circuit board layout depicting part of the circuit of FIG. 1.

### DESCRIPTION OF THE PREFERRED EMBODIMENT

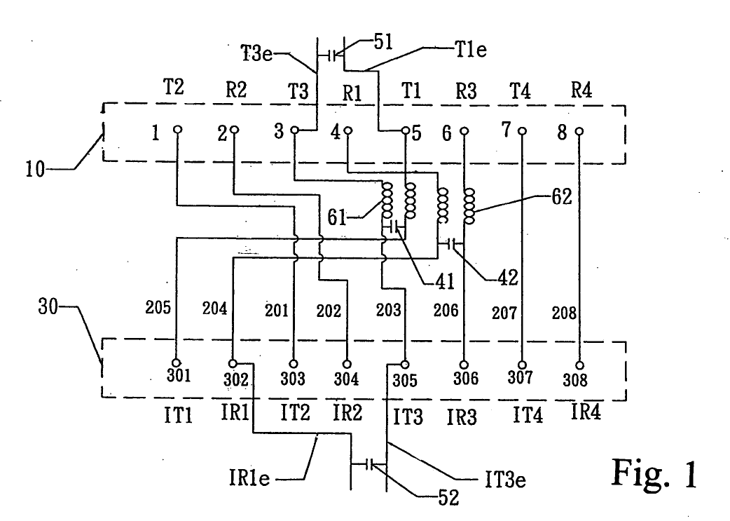

With reference to FIG. 1, a preferred embodiment of the invention is depicted in an electrical schematic mode. An information receptacle's double sided Printed Circuit Board (PCB) circuit is primarily comprised of an information insertion jack 10, an IDC 30, a number of pairs of power condensers 41, 42, 51, 52, a number of pairs of power inductors 61, 62, and a number of terminal leads 1 to 8. Main lead wires 201 to 208, located on both sides of the PCB, link information jack 10 to IDC 30. Information jack 10 contains 8 pins, which from left to right are in a sequential order of 1 to 8. Pins 1 to 8 are considered in the following pairs of pins: pair one consists of pins 5,4; pair two consists of pins 1,2; pair three consists of pins 3,6; and pair four pins consist of pins 7,8. Connected to pins 3 and 5 are extension lead wires T1e and T3e, respectively. Pair one's pin 5, 4 are identified as T1, R1; pair two's pin 1, 2 are identified as T2, R2; pair three's pin 3, 6 are identified as T3, R3; and pair four's pin 7, 8 are identified as T4, T4.

IDC terminal 30 also has 8 pins, which from left to right are in a sequential order of 301 to 308. The layout of the eight pins has each subsequent two adjacent pins divided as one pair, from left to right in sequential order of four pairs. Pair one's pins 301, 302 are identified as IT1, WR1; pair two's pins 303, 304 are identified as IT2, IR2; pair three's pins 305, 306 are identified as IT3, IR3; pair four's pins 307, 307 are identified as IT4, IR4. There are two extension lead wires, IR1e and IT3e that are connected respectively at one end thereof to pins 302 and 305.

Within IDC jack 30 the PCB's pair one pin 4 and pin 5 placed on two sides of a PCB, pair three's pin 3 and pin 6 are also separated and placed on two sides of a PCB, meaning that pin 3, 5 are on one side of a PCB, and pin 4, 6 on the other side of a PCB. As a result of this special arrangement, the pin pairs located on two sides of a PCB form an equalization structure between the power inductor and power condenser that helps the IDC terminal 10 achieve a reduced cross-talk and improve its return-loss.

At information jack 10, where pin 3, 5 are located on the same side of the PCB, some of the main leads 203, 205 are placed near and linked to IDC terminal 30's pin 301, 305 to form pair one's power inducting effect 61 and pair one's power condensing effect 41. Similarly, at jack 10 where pin 4, 6 are located on the same side, some of the main leads 204, 206 are placed near and linked to IDC 30's pin 302, 306 to form pair two's power inducting effect 62 and pair two's power condensing effect 42.

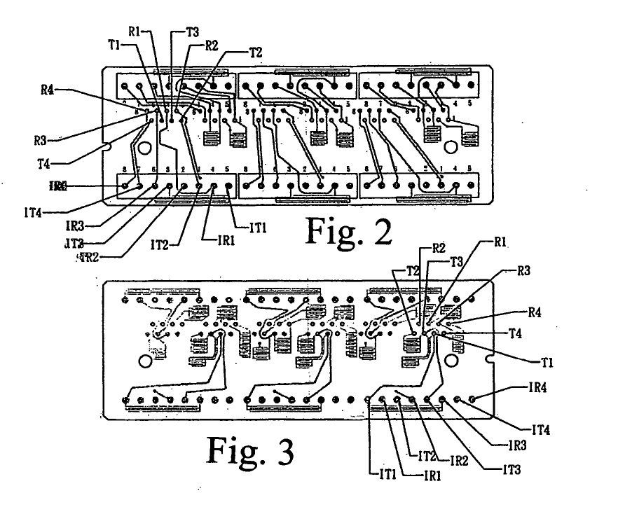

Connected at information jack 10 to each set of pins, pins 4, 6 and pins 3,5's is a power condenser structure. This power condenser structure primarily utilizes two pairs of forked parallel extension leads to connect with pins 3 and 5 of information terminal 10 to form pair three's power condenser effect 51. This allows the two pairs of lead wires to from a TT, RR polarity configured power condenser, which is comprised of a section of extension wire T3e, T1e connected to the information jack 10's leads T3, and T1. This actually constitute pair three's extension leads T3e, T1e to the condenser 51. When manifested in a circuit board layout (FIG. 2 and FIG. 3), this is a an illustrated example of a type of patch panel circuit board surface, fitting with six information jacks 10 and six wiring terminals 30.

The pin 3, 4 or pin 5, 6 of the power condenser structure linked to the IDC terminal 30 primarily utilizes two pairs of cross parallel and closely placed extension leads linking to IDC 30's two pins to create pair four's power condenser effect 52, allowing this pair's leads to form a TR polarization configured power condenser, which is linked to pair four's power condenser effect 52 of the IDC 30 pins IT3, IR1 extension leads IT3e, IR1e for counterbalance.

With particular reference to FIGS. 2 and 3, there is depicted a modified Printed Circuit Board (PCB) containing three substantially identical sections. Each section has an upper information jack or terminal and a lower IDC terminal. Each terminal has a horizontal line of eight numbered pins (but not numbered sequentially) and the eight pins are grouped into four pairs of adjacent pins which are, starting on the right side as shown in FIG. 2: a pair one with pins 5,4; a pair two with pins 1,2; a pair three with pins 3,5; and a pair four with pins 7,8.

The circuitry of FIGS. 2 and 3 reveals that the proximity compensation effect of pins 4,5 located on the same side, the proximity compensation effect with pin 3,6 located on the same side, and the effect of the information jack and IDC lead terminal that come to form a pair of impedance is unable to pair with the circuit's 100 Ω impedance. And when its cross-talk surpasses category six protocols, the impedance shift derived from the allocation of the foresaid power inducting and power condensing effects will severely hinder the return loss from passing category-six communications protocols.

As analyzed through a high-frequency networking analyzer of the invention's actual figures in a close proximity cross-talk, when pair one and pair two's leads are at 250 MHz frequency, the close-range cross-talk rating is at 58.86 dB; when at 200 MHz frequency, the close-range cross-talk rating is at 77.33 dB; when at 250 MHz frequency, the close-range cross-talk rating is at 47.47 dB; when at 200 MHz, the close-range cross-talk frequency is at 55.33 dB; when at 100 MHz frequency, the cross-talk rating is at 59.52 dB. When pair one and par four's leads are at 250 MHz frequency, the close-range cross-talk rating is at 55.91 dB; when at 200 MHz frequency, the close-range cross-talk rating is at 59.81 dB; when at 100 MHz frequency, the close-range cross-talk rating is at 71.12 dB. When pair two and pair three's leads are at 250 MHz, the close-range cross-talk rating is at 48.43 dB; when at 200 MHz frequency, the close-range cross-talk frequency rating is at 50.26 dB; when at 100 MHz frequency, the close-range cross-talk rating is at 55.08 dB. When pair two and pair four leads are at 250 MHz frequency, the close-range cross-talk rating is at 62.93 dB; when at 200 MHz frequency, the close-range cross-talk rating is at 64.61 dB; hen at 100 MHz, the close-range cross-talk rating is at 71.62 dB. When pair three and pair four's leads are at 250 Hz, the close-range cross-talk rating is at 51.5 dB; when at 200 MHz frequency, the close-range cross-talk rating is at 55.52 dB; when at 100 MHz frequency, the close-range cross-talk rating is at 65.06 dB. When compared the foresaid experiment figures to cross-talk ratings under category six communications protocols, as per the category six cross-talk rating table, the close-range cross-talk rating at 250 MHz frequency is at 46 dB, and at 200 MHz at 48 dB, and at 100 MHz at 54 dB, which reveal that the experiment figures tested by adopting the invention have indeed surpassed category six near-range cross-talk criteria, and also surpass a well-known prior case's (Taiwan patent listing number 90216170) close-range cross-talk testing figures.

Of the invention's actual return-loss figures, when pair two leads are at 250 MHz frequency the cross-talk rating is at 22.8 dB; when at 200 MHz frequency, the cross-talk rating is at 26.07 dB; when at 100 MHz, the close-range cross-talk rating is at 34.14 dB. When pair three's leads are at 250 MHz frequency, the close-range cross-talk rating is at 32.64 dB; when at 200 MHz frequency the close-range cross-talk rating is at 38.43 dB; when at 100 MHz frequency, the close-range cross-talk rating is at 37.55 dB. When first pair's leads are at 250 MHz frequency, the close-range cross-talk rating is at 21.78 dB; when at 200 MHz frequency, the close-range cross-talk rating is at 24.19 dB; when at 100 MHz frequency, the close-range cross-talk rating is at 34.93 dB. These results reveal that the findings of experiment figures derived from tests conducted using the invention have indeed greatly exceeded category six return-loss criteria, and also surpassed the return-loss testing figures of the well known prior case. By comparing the two, the invention can indeed effectively reduce cross-talk interference, exceed the quality of high-frequency signal transmission, and increase the stability of product quality.

While the invention has been particularly shown and described with reference to a particular embodiment, it will be appreciated that various modifications of the above-disclosed embodiment and other features and functions, or alternatives thereof, may be desirably combined into many other different systems or applications. Also, the various presently unforeseen and unanticipated alternatives, modifications, variations, or improvements therein may be subsequently made by those skilled in the art which are also intended to be encompassed by the following claims. Although the invention has been described with reference to specific preferred embodiments, it is not intended to be limited thereto, rather those having ordinary skill in the art will recognize that variations and modifications may be made therein which are within the spirit of the invention and within the scope of the claims.

I claim:

1. A double sided Printed Circuit Board (PCB) layout comprised of:
an information jack having a number of pins configured into a plurality of pairs of pins;
an IDC terminal having a number of pins configured into a plurality of pairs of pins;
wherein a pair one of said information jack pins is comprised of pins 4 and 5 and a pair three of pins is comprised of pins 3 and 6, and wherein said pins 4 and 5 are separated and placed on different sides of said PCB and said pins 3 and 6 are separated and placed on different sides of said PCB;
a number of main leads distributed on said two sides of said PCB and connecting said information jack pins with said IDC terminal pins such that the circuit board's information jack pins and IDC terminal's pins are interconnected, and in particular a pair one;
a first and a second power condenser;
a first and a second power inducer;
wherein one of said two power condensers and one of said two power inducers are located on one side of said PCB and are connected to at least one of said pins of said information jack and to one of said pair one pins and one of said pair three pins of said IDC terminal; and
wherein the second power condenser and the second power inducer are located on the second side of said PCB and are connected to at least one of said pins of said information jack and are connected to the second of said pair one pins and the second of said pair three pins of said IDC terminal;
a third power condenser connected by a first extension lead and a second extension lead to two respective pins on said information jack, said third power condenser being a TT or an RR polarized configured power condenser; and
a fourth power condenser connected by a third extension lead and a fourth extension lead to two respective pins on said IDC terminal, said fourth power condenser being a TR polarized configured power condenser.

2. An information jack's circuit board layout as recited in claim 1, wherein pair one's pin 3, 4 of the circuit board linked to the information jack are separated and placed on different sides of a printed circuit board (PCB), and pair three's pin 5, 6 are separated and placed also on different sides of said PCB, such that pin 3, 5 are located on the same side of a PCB and pin 4, 6 on the other side of said PCB.

3. An information jack's circuit board layout as recited in claim 1, wherein said pair one's main leads are comprised of a first main lead linked to the information jack pin 3, and a second main lead linked to the information jack's pin 4; and pair three's main leads are comprised of a third main lead linked to the information jack's pin 5, and a fourth main lead linked to the information jack's pin 6.

4. An information jack's circuit board layout as recited in claim 3,
wherein a pair one of said IDC terminal pins is comprised of pins 301 and 302 and a pair three of pins is comprised of pins 305 and 306;
wherein the first and third main leads on one end of the PCB are linked to pin 3 and pin 5 and are located in close proximity to form power condenser one and power inductor one, which are connected to the IDC terminal pins 301, 305; the second and fourth main leads are located on the other side of the PCB are placed in close proximity to form power condenser two and power inductor two, which are then connected separately to the IDC internal pins 302, 306.

5. An information jack's circuit board layout as recited in claim 4, wherein the power condenser and power inductor are comprised of having some of the first and third main leads placed in a close proximity, and some of the second and fourth main leads on the other side placed in a close proximity.

6. An information jack's circuit board layout as recited in claim 1, wherein the PCB power condenser three's extension lead is connected to the information jack's pin 3, and the other extension lead is connected to the information jack's pin 5 to form a 17 polarized configured power condenser.

7. An information jack's circuit board layout as recited in claim 1, wherein the PCB power condenser three's extension lead is connected to the information jack's pin 4, and the other extension lead is connected to the information jack's pin 6 to form an RR polarized configured power condenser.

8. An information jack's circuit board layout as recited in claim 1, wherein the PCB power condenser four's extension lead is connected to the information jack's pin 3, and the other extension lead is connected to the information jack's pin 4 to form a TR polarized configured power condenser.

9. An information jack's circuit board layout as recited in claim 1, wherein the circuit board's fourth power condenser's extension lead is linked to the IDC terminal's pin four, and its other extension lead is linked to the information jack's pin 6 to form a TR polarized configured power.

10. An information jack's circuit board layout as claimed in claim 1 wherein said fourth power condenser structure linked to said IDC terminal comprised two pairs of cross parallel and closely placed extension leads linking to two pins of said IDC terminal to create pair four's power condenser effect, thereby allowing aforesaid two pairs of leads to form a TR polarization configured power condenser, which is linked to pair four's power condenser of said IDC terminal pins and extension leads for counterbalance.
